(19) United States
(12) Patent Application Publication
(10) Pub. No.: US 2014/0055947 A1
(43) Pub. Date: Feb. 27, 2014

(54) HEAT DISSIPATION DEVICE FOR A NOTEBOOK COMPUTER

(71) Applicant: QUATIUS LIMITED, Hong Kong (CN)

(72) Inventor: Chao Jiang, Hong Kong (CN)

(73) Assignee: QUATIUS LIMITED, Hong Kong (CN)

(21) Appl. No.: 13/733,101

(22) Filed: Jan. 2, 2013

(30) Foreign Application Priority Data
Aug. 27, 2012 (CN) 201220429525.3

(51) Int. Cl. G06F 1/20

(52) U.S. Cl. CPC G06F 1/203
USPC 361/679.47; 361/679.54

(57) ABSTRACT

A heat dissipation device for a notebook computer includes a heat dissipating plate and a bracket for supporting the heat dissipating plate. When the notebook computer is positioned on the heat dissipating plate, the notebook computer tends to slip towards the first side closest to the user rather than the second side away from the user, as the bracket makes the first side lower than the second side. Because a protrusion is provided on the bracket close to the first side, the tendency of slipping towards the first side is stopped by the protrusion, preventing the notebook from slipping off the heat dissipation device. This ensures the security of the notebook computer when it is used with the heat dissipation device.

### FIELD

The present invention relates to notebook computer auxiliary peripherals, and more particularly to a heat dissipation device for a notebook computer.

### BACKGROUND

A notebook is a portable computer which also possesses the function of a desktop computer. Because of its compact and flat design, all components of it are installed side by side closely, which may result in low efficiency heat dissipation. When a notebook computer is in operation, especially in hot summer when the temperature is high, the notebook computer will often suffer from slow response speed or even system crashes due to slow heat dissipation, causing great inconvenience for the user.

At present, there are many types of heat dissipation devices on the market that require the notebook computer to be positioned on the heat dissipation device. Heat generated by the notebook computer is dissipated by fans provided in the heat dissipation device, which achieves the aim of heat dissipating. However, the heat dissipation device for use with the notebook computer has a certain height itself, which may cause the notebook computer seated above the heat dissipation device to slip and be damaged, affecting the security of the notebook computer.

### SUMMARY

Based on this, there is a need to provide a heat dissipation device for a notebook computer aimed at preventing slips and damage to the notebook computer.

A heat dissipation device for a notebook computer includes a heat dissipating plate and a bracket for supporting the heat dissipating plate, wherein the heat dissipating plate has a first side closer to the user, and a second side away from the user. The bracket makes the first side of the heat dissipating plate lower than the second side of the heat dissipating plate, and the bracket is provided with a protrusion close to the first side of the heat dissipating plate.

In an embodiment, the protrusion is one-piece integrally formed in the bracket. In an embodiment, the protrusion has a height of 20-28 mm.

In an embodiment, a heat dissipation gap is provided between the protrusion of the bracket and the first side of the heat dissipating plate.

In an embodiment, anti-slip pads are provided where the bracket touches a supporting surface.

In an embodiment, the bracket is integrally formed as a single piece, and the heat dissipating plate is fixed or removably attached into the bracket.

In an embodiment, the heat dissipating plate is provided with a heat dissipating mesh and/or a heat dissipating fan.

In an embodiment, the heat dissipating plate is provided with at least two data interfaces.

In an embodiment, the heat dissipating plate is provided with a power supply interface.

In an embodiment, the heat dissipating plate is provided with a power supply switch and a power supply indicator.

When in use, the notebook computer is placed on the heat dissipating plate; the notebook computer tends to slip towards the first side other than the second side for the first side is lower than the second side. Because of the protrusion provided on the bracket close to the first side, the tendency of slipping towards the first side is stopped by the protrusion, which prevents the notebook from slipping off the heat dissipation device. This ensures the security of the notebook computer when it is used with the heat dissipation device.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a structural schematic diagram of a heat dissipation device for use with a notebook computer;

FIG. 2 shows another view of a structural schematic diagram of a heat dissipation device for use with a notebook computer;

FIG. 3 shows another view of a structural schematic diagram of a heat dissipation device for use with a notebook computer; and

FIG. 4 shows yet another view of a structural schematic diagram of a heat dissipation device for use with a notebook computer.

### DETAILED DESCRIPTION

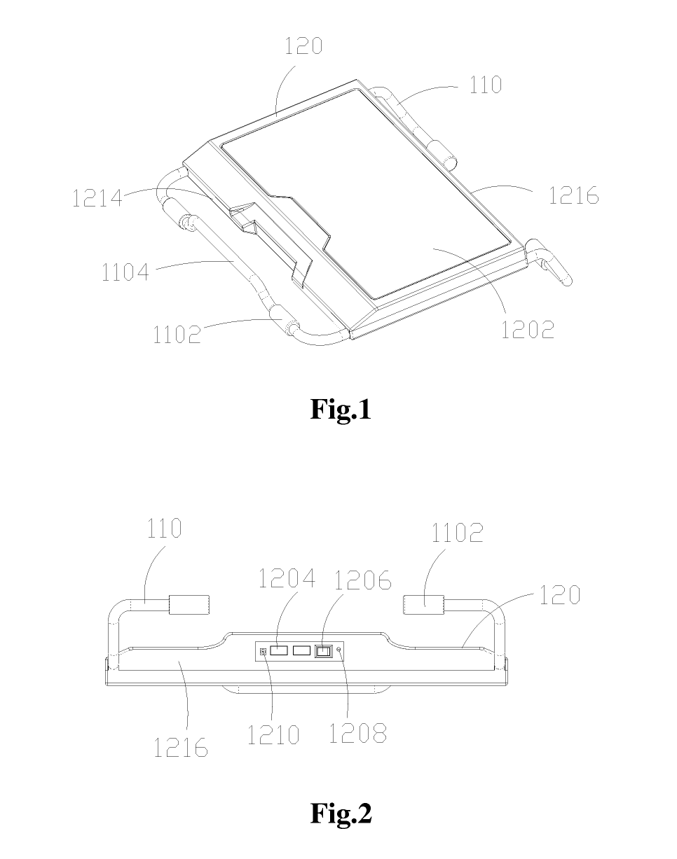

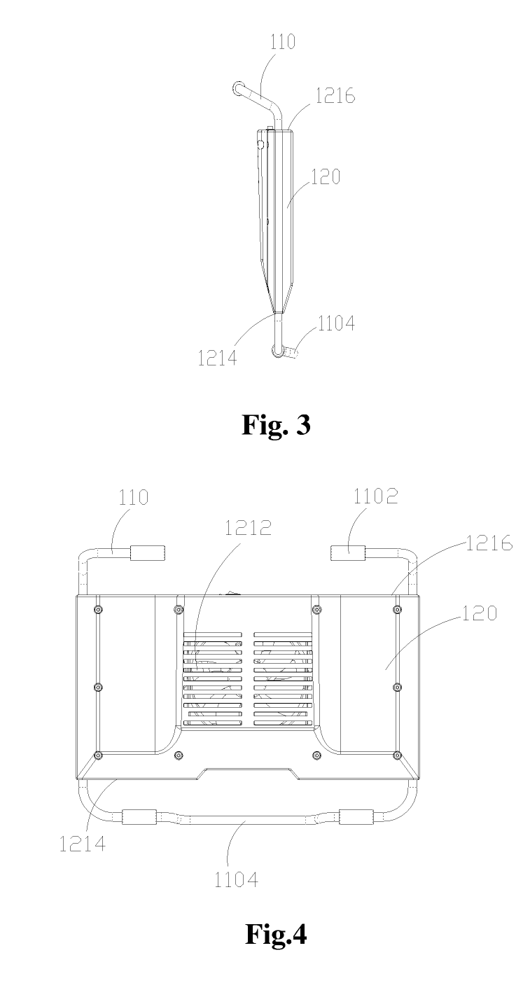

As illustrated in FIG. 1 to FIG. 4, a heat dissipation device of a notebook computer includes a heat dissipating plate 120 and a bracket 110 for supporting the heat dissipating plate 120. The heat dissipating plate 120 has a first side 1214 which is the side closest to the user, and a second side 1216 which is the side further from the user. The bracket 110 makes the first side 1214 lower than the second side 1216. Additionally, the bracket 110 is provided with a protrusion 1104 close to the first side 1214.

When in use, the notebook computer is placed on the heat dissipation plate 120. The notebook computer tends to slip to the first side 1214 rather than the second side 1216 since the first side 1214 is lower than the second side 1216. Because of the protrusion 1104 provided on the bracket 110 close to the first side 1214, the tendency of slipping to the first side 1214 is prevented by the protrusion 1104, which prevents the notebook from slipping off the heat dissipation device. This ensures the security of the notebook computer when it is used with the heat dissipation device.

In one embodiment, the protrusion 1104 is one-piece integrally formed in the bracket 110, which simplifies the structure of the device, makes it easy to manufacture, and saves cost. Nevertheless, the protrusion and the bracket can be produced separately in other embodiments, which can also protect the notebook computer by blocking the slipping of the notebook computer.

In one embodiment, the protrusion 1104 of the bracket 110 has a protruding height of 20-28 mm. A common notebook computer has a thickness of 15-30 mm, more commonly 20-28 mm. Therefore, it is preferable that the protruding height is 20-28 mm, which prevents the notebook computer from slipping, and the protrusion will not interfere with the user's hands when in operation.

In one embodiment, a heat dissipation gap is provided between the protrusion 1104 of the bracket 110 and the first side 1214 of the heat dissipating plate. When placing a notebook computer on the heat dissipating plate 120, by leaving the heat dissipation gap between the protrusion 1104 and the first side 1214 of the heat dissipating plate 120, the heat dissipating plate 120 will not completely cover the whole bottom surface of the notebook computer. Heat dissipation performance of the heat dissipation device will be improved by dissipating heat in the areas that need to be cooled, and leaving the areas that do not need to be cooled in direct contact with air.

In one embodiment, anti-slip pads 1102 are provided where the bracket 110 touches a supporting surface. The anti-slip pads 1102 increase the friction between the bracket 110 and the supporting surface, so as to prevent the heat dissipation device from slipping on the surface, and further to prevent the notebook computer from slipping off, due to slipping of the heat dissipation device.

In the embodiment illustrated in FIG. 1, the bracket 110 is one piece, integrally formed. More specifically, the bracket 110 can be formed by bending a rigid rod. The heat dissipating plate 120 is supported and fixed by the bracket 110 which passes through the heat dissipating plate 120. This type of one-piece bracket 110 is simple in structure, easy to manufacture, and low cost. It should be understood that in other embodiments, the bracket 110 can also be arranged in separate parts that are installed respectively on the first side 1214 and the second side 1216 of the heat dissipation plate 120. This does not affect the supporting function of the bracket to the heat dissipating plate.

In one embodiment, the heat dissipating plate 120 is fixed to the bracket 110 such that the heat dissipating plate 120 will not easily move or slip, enhancing safety in use.

In other embodiments, the heat dissipating plate 120 may be removably attached to the bracket 110. For example, the heat dissipating plate 120 can be installed on the bracket 110 in a sliding manner that allows the position of the heat dissipating plate 120 on the bracket 110 to be adjusted according to the size of the notebook or the user's habits so as to be more convenient.

As illustrated in FIG. 1, in one embodiment, the heat dissipating plate 120 can be provided with a heat dissipating mesh 1202, which is located above the top surface of the heat dissipating plate 120, directly in contact with the bottom of the notebook computer that is to be cooled. The aim of heat dissipation is achieved by providing heat dissipating material in contact with the bottom of the notebook computer. The heat dissipation mesh 1202 can be metal for its heat dissipation effect.

As illustrated in FIG. 4, in one embodiment, the heat dissipating plate 120 can be provided with a heat dissipating fan 1212, that is located inside the heat dissipating plate 120. As can be seen in FIG. 4, the bottom surface of the heat dissipating plate 120 overlapping the heat dissipating fan 1212 is hollow, and the heat dissipating fan dissipates heat by speeding up the air flow.

It should be understood that the heat dissipating mesh 1202 and the heat dissipating fan 1212 are provided to improve the heat dissipating effect. As a result, it is possible to provide both the heat dissipating mesh 1202 and the heat dissipating fan 1212 in the heat dissipating plate 120, so as to achieve good heat dissipating effect. It is also possible to provide only the heat dissipating mesh 1202 or the heat dissipating fan 1212, which does not affect the heat dissipating purpose of the heat dissipating plate 120.

In one embodiment, the heat dissipating plate 120 can be provided with data interfaces 1204, as illustrated in FIG. 2. There can be two or more data interfaces 1204. When the heat dissipation device is working, it is powered by connecting the data interface 1204 with a data interface of the notebook computer. By providing at least two data interfaces 1204, the number of data interfaces of the notebook computer is also increased, solving the problem of a lack of data interfaces. The data interfaces 1024 can be USB ports or the like.

Certainly, in other embodiments, the heat dissipating plate 120 can also be provided with a power supply interface 1210, via which the device can be powered by a power source other than being powered via the data interface 1204 by connecting with the notebook computer. This is especially helpful when the notebook computer is working using its own battery instead of an outside power source. By connecting the power supply interface 1210 with a power source, the notebook computer using its own battery would be able to work for a longer time, as the heat dissipation device will not consume its power.

In an embodiment, the heat dissipating plate 120 is provided with a power switch 1206 and a power supply indicator 1208. It is more convenient to control the active condition of the heat dissipation device of the notebook by the power switch 1206. On the other hand, when the heat dissipation device is being used as a seat for the notebook computer without utilizing the heat dissipating function, the power supply switch 1206 may be pressed and the heat dissipation device of the notebook computer will stop working. When the power supply indicator 1208 is ON, it indicates that the heat dissipation device is working to provide its heat dissipating function, and vice versa, which is convenient for the user to check the working status of the heat dissipation device.

The above embodiments only describe several embodiments of the present invention, which should not be considered as limiting the scope of the present invention. It should be understood that those skilled in the art can make many variations and modifications which fall into the protection scope of the present invention without departing from the spirit of the present invention. Accordingly, the scope of the present invention is defined by the appended claims.

1. A heat dissipation device for a notebook computer, comprising:
a heat dissipating plate; and
a bracket for supporting the heat dissipating plate;
wherein the heat dissipating plate has a first side closer to a user and a second side away from the user,
wherein the bracket makes the first side of the heat dissipating plate lower than the second side of the heat dissipating place, and
wherein the bracket is provided with a protrusion close to the first side of the heat dissipating plate.

2. The heat dissipation device of claim 1, wherein the protrusion is one-piece integrally formed in the bracket.

3. The heat dissipation device of claim 1, wherein the protrusion has a height of 20-28 mm.

4. The heat dissipation device of claim 1, wherein a heat dissipation gap is provided between the protrusion of the bracket and the first side of the heat dissipating plate.

5. The heat dissipation device of claim 1, wherein anti-slip pads are provided where the bracket touches a supporting surface.

6. The heat dissipation device of claim 1, wherein the bracket is integrally formed as a single piece and the heat dissipating plate is fixed to the bracket.

7. The heat dissipation device of claim 1, wherein the heat dissipating plate is provided with a heat dissipating mesh.

8. The heat dissipation device of claim 1, wherein the heat dissipating plate is provided with at least two data interfaces.

9. The heat dissipation device of claim 1, wherein the heat dissipating plate is provided with a power supply interface.

10. The heat dissipation device of claim 1, wherein the heat dissipating plate is provided with a power supply switch and a power supply indicator.

11. The heat dissipation device of claim 1, wherein the bracket is integrally formed as a single piece and the heat dissipating plate is removably attached to the bracket.

12. The heat dissipating device of claim 11, wherein the heat dissipating plate is installed on the bracket in a sliding manner that allows the position of the heat dissipating plate on the bracket to be adjusted.

13. The heat dissipation device of claim 7, wherein the heat dissipating mesh is located above a top surface of the heat dissipating plate, directly in contact with a bottom of the notebook computer that is to be cooled.

14. The heat dissipation device of claim 1, wherein the heat dissipating plate is provided with a heat dissipating fan.
